(19) United States
(12) Patent Application Publication
(10) Pub. No.: US 2017/0341739 A1
(43) Pub. Date: Nov. 30, 2017

(54) VARIABLE AMPLITUDE FORCE GENERATOR

(71) Applicant: Sikorsky Aircraft Corporation, Stratford, CT (US)

(72) Inventors: Jordan Alex Kaye, Shelton, CT (US); Marcus D. Cappelli, Shelton, CT (US); Michael Monico, North Haven, CT (US)

(21) Appl. No.: 15/536,478

(22) PCT Filed: Oct. 15, 2015
(86) PCT No.: PCT/US15/55743

§ 371 Date: Jun. 15, 2017

Related U.S. Application Data
(60) Provisional application No. 62/092,557, filed on Dec. 16, 2014.

(51) Int. Cl. B64C 27/00; B64C 27/14; B64C 27/32; B64C 27/82

(52) U.S. Cl. CPC B64C 27/001; B64C 27/82; B64C 27/14; B64C 27/32

(57) ABSTRACT

A force generator includes a hub, which is rotatable about an axis thereof, an elongate member coupled to the hub such that the elongate member is rotatable with the hub and extends radially outwardly away from the hub and the axis along a radial dimension defined with respect to the axis and a mass, which is movably disposed along the elongate member and is adjustable to multiple radial mass positions relative to the hub.

### CROSS-REFERENCE TO RELATED APPLICATION

The present application is a 371 National Stage of International Patent Application No. PCT/US2015/055743, filed Oct. 15, 2015, which claims priority to U.S. Provisional Patent Application No. 62/092,557, filed Dec. 16, 2014, the contents of which are incorporated herein by reference in their entirety.

### STATEMENT REGARDING FEDERALLY SPONSORED RESEARCH OR DEVELOPMENT

This invention was made with government support under agreement number W911W6-12-2-0005 awarded by the Army. The government has certain rights in the invention.

### BACKGROUND OF THE INVENTION

The subject matter disclosed herein relates to force generators and, more particularly, to variable amplitude force generators.

In rotary aircraft, such as single-rotor helicopters or helicopters with coaxial, counter-rotating main rotors, the rotors rotate about the airframe and generate vibration. This vibration as well as other types of vibration (e.g., those caused by damage) are transmitted to the airframe and can lead to uncomfortable flight conditions. Thus, it is often desirable that at least a portion of the generated vibration be mitigated or reduced. Such vibration mitigation or reduction is often achieved by providing rotary aircraft with force generator systems.

Current force generator systems use fixed weights and are designed to accelerate the weights in a given direction in order to effectively interfere with the vibrations and in so doing to achieve the desired vibration mitigation or reduction. However, these current force generator systems are typically designed to target a single frequency. Thus, if a force generator is to cancel vibration at a frequency for which it was not designed, it must be adapted to cancel vibration at the new frequency.

### BRIEF DESCRIPTION OF THE INVENTION

According to one aspect of the invention, a force generator includes a hub, which rotates about an axis thereof, an elongate member coupled to the hub such that the elongate member is rotatable with the hub and extends radially outwardly away from the hub and the axis along a radial dimension defined with respect to the axis and a mass, which is movably disposed along the elongate member and is adjustable to multiple radial mass positions relative to the hub.

In addition to one or more of the features described above, or as an alternative, the hub includes a cylindrical body and the axis is a central longitudinal axis of the cylindrical body.

In addition to one or more of the features described above, or as an alternative, the elongate member extends radially outwardly from a radial periphery of the hub.

In addition to one or more of the features described above, or as an alternative, the elongate member extends perpendicularly with respect to the axis.

In addition to one or more of the features described above, or as an alternative, the force generator includes an actuator to drive a movement of the mass.

In addition to one or more of the features described above, or as an alternative, the actuator includes a rotary actuator which rotates the elongate member to move the mass relative to the hub.

In addition to one or more of the features described above, or as an alternative, the actuator includes a linear actuator which moves the mass relative to the hub along the elongate member.

In addition to one or more of the features described above, or as an alternative, the actuator is disposed within the elongate member.

In addition to one or more of the features described above, or as an alternative, the actuator includes a controller which controls the actuator to control a movement of the mass along the elongate member and to drive a rotation of the hub about the axis for each force generator to mitigate at least one vibratory frequency having an amplitude.

In addition to one or more of the features described above, or as an alternative, the controller further changes a rotational speed of the hub and moves the mass to change from one frequency of amplitude X to another frequency having amplitude Y, where the amplitude X is other than the amplitude Y.

According to another aspect, an aircraft is provided and includes an airframe, a rotor disposed on the airframe, a drive system disposed within the airframe and coupled to the rotor to drive a rotation of the rotor relative to the airframe and a system. The system includes at least one or more force generators disposed on the airframe or on components of the rotor or the drive system and a controller configured to control a movement of the mass along the elongate member and to drive a rotation of the hub about the axis for each force generator to mitigate or reduce at least one vibratory frequency generated by rotor rotation and/or aircraft damage.

In addition to one or more of the features described above, or as an alternative, the vibratory frequency is a design frequency of the system.

In addition to one or more of the features described above, or as an alternative, the vibratory frequency is a non-design frequency of the system, and the controller adjusts the rotation of the hub and a radial location of the mass to mitigate the non-design frequency.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of an aircraft in accordance with embodiments;

FIG. 2 is a schematic diagram of a drive system of the aircraft of FIG. 1 in accordance with embodiments;

FIG. 3 is a side view of a force generator in accordance with embodiments;

FIG. 4 is a schematic diagram illustrating a control system for the force generator of FIG. 3; and

FIG. 5 is a flow diagram illustrating a method of controlling a system of force generators for an aircraft.

The detailed description explains embodiments of the invention, together with advantages and features, by way of example with reference to the drawings.

### DETAILED DESCRIPTION OF THE INVENTION

As will be described below, a force generator can be used to cancel vibratory content at a frequency for which it was not designed by changing operational speeds of the force generators of the current force generator systems. However, the change can result in a reduction in authority (i.e., force generator amplitude) of the generated force being reduced with corresponding reductions in efficiencies or effectiveness of the system. A force generator is provided and has the capability of being controlled such that the weights of the force generator can move radially inward or outward. Thus, a moment arm of the force generator can be changed to allow, for example, higher amplitude forces to be generated even if the rotational speed of the force generator is reduced. This will allow the force generator to maintain efficiency at different rotational velocities and will allow the force generator to mitigate or reduce the vibratory content at its design frequency and to mitigate or reduce vibration at multiple frequencies other than its design frequency. This can be particularly useful in a case where the aircraft has been damaged and the damage causes non-design frequency vibration.

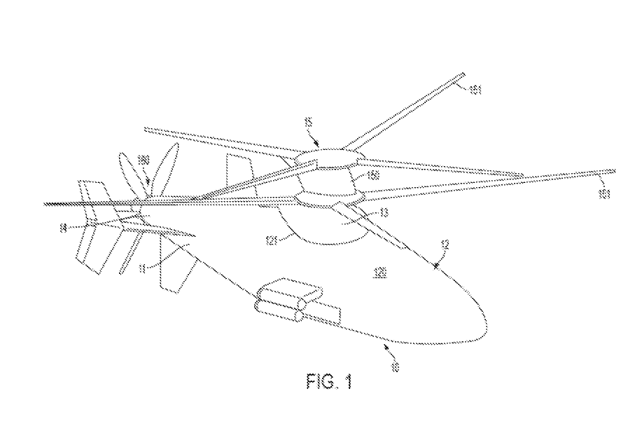

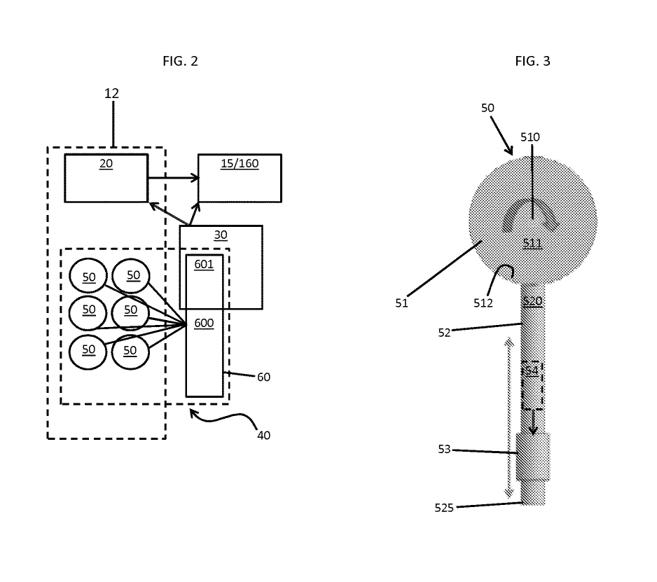

With reference to FIGS. 1 and 2, an aircraft 10 is provided. The aircraft 10 may be a helicopter 11 or another similar type of rotary aircraft. As shown in FIG. 1, the aircraft 10 includes an airframe 12, which is formed to define a cabin 120 and which includes a main section 121, a pylon section 13 and a tail section 14. The pylon section 13 is supportive of a main rotor section 15 that includes a main rotor shaft 150 and main rotors 151, which are coupled to the main rotor shaft 150. The tail section 14 is supportive of a propeller assembly 160. The cabin 120 is sized to accommodate a pilot and, in some cases, additional crewmen and/or passengers as well as control and navigational features.

The aircraft 10 further includes a drive system 20, a flight computer 30 and a vibration reduction system 40. The drive system 20 is disposed within the airframe 12 and is coupled to the main rotor section 15 and the propeller assembly 160 to drive respective rotations of the main rotors 151 and the propeller assembly 160 relative to the airframe 12. The drive system 20 may include an engine and a transmission system including one or more gearboxes. In such cases, the engine generates power to drive the respective rotation of the main rotors 151 and the propeller assembly 160 and the transmission system transmits the generated power to the main rotor section 15 and the propeller assembly 160. The flight computer 30 is coupled to the drive system 30, the main rotor section 15 and the propeller assembly and is configured to control various operations of each.

As shown in FIG. 1, the aircraft 10 may be provided as a helicopter 11 having first and second coaxial, counter-rotating main rotors with the propeller assembly 160. It will be understood that this is not required, however, and that the description provided herein is applicable for any aircraft or ground based turbine. By way of example, a conventional single rotor helicopter could be used having a tail rotor which is not an auxiliary propeller.

The vibration reduction system 40 includes force generators 50 that are disposed on or about the airframe 12, a transmission of the drive system 20 or a rotor head of the main rotor section 15 or the propeller assembly 160 and a controller 60 that may be provided as a stand-alone feature 600 or as a sub-component 601 of the flight computer 30. While shown with plural force generators 50, it is understood that a single force generator 50 could be used in other aspects, and where plural force generators 50 are used, the number could be other than the six shown.

With reference to FIG. 3, at least one of the force generators 50 includes a hub 51, an elongate member 52 and a mass 53. The hub 51 is fixable to the airframe 12 at a given location and rotates (or revolves) about an axis 510 thereof. In accordance with embodiments, the hub 51 may include or be provided as a cylindrical body 511 having a radial periphery 512 and the axis 510 may be a central longitudinal axis of the cylindrical body 511. The elongate member 52 includes a shaft 520 and is coupled at an end of the shaft 520 to the hub 51 such that the elongate member 52 is rotatable with the hub 51 and extends radially outwardly away from the axis 510 of the hub 51 along a radial dimension defined substantially perpendicular to the axis 510. In accordance with embodiments, the elongate member 52 extends radially outwardly from the radial periphery 512 of the hub 51 and perpendicularly with respect to the axis 510. The mass 53 is movably disposed along the shaft 520 of the elongate member 52 to assume multiple radial mass positions relative to the hub 51. These multiple radial mass positions may be defined anywhere along the shaft 520 between the periphery 512 of the hub 51 and a distal end 525 of the shaft 520 of the elongate member 52.

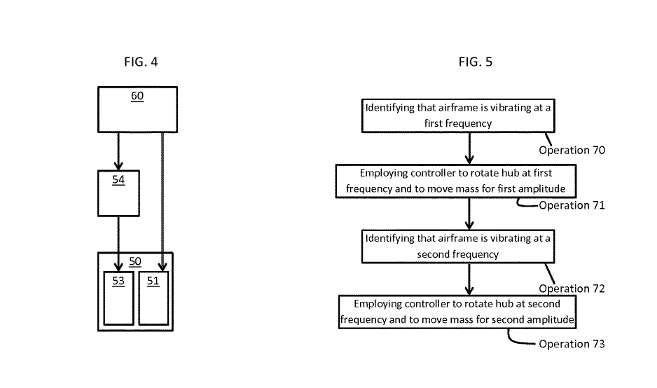

With continued reference to FIG. 3 and with additional reference to FIG. 4, the one or more of the force generators 50 may further include an actuator 54. The actuator 54 may be external from the elongate member 52 or disposed within the shaft 520 of the elongate member 52 and coupled to the mass 53. By way of such coupling, the actuator 54 is configured to drive a movement of the mass 53 along the shaft 520. In accordance with alternative embodiments, the actuator 54 may be a rotary actuator or a linear actuator. In the former case, the mass 53 may be secured to the shaft 520 via threading whereby rotation of the rotary version of the actuator 54 causes rotation of the mass 53 about the shaft 520, which is converted into linear motion by the threading. Where the actuator 54 is a linear actuator, actuation of the actuator 54 directly causes linear motion of the mass 53.

The controller 60 is coupled to the one or more of the force generators 50 and is thus configured to control a movement of the mass 53 along the shaft 520 of the elongate member 52 and to drive the rotation of the hub 51 about the axis 510 at a frequency (or frequencies) that is (or are) in line with a frequency (or frequencies) currently affecting the airframe 12. In doing so, the controller 60 operates the one or more of the force generators 50 to mitigate or reduce vibrations of the airframe 12. In accordance with embodiments, these vibrations may be caused by at least one or more of vibrations generated by the respective rotations of the main rotors 151 and the propeller assembly 160 and/or by damage to the aircraft 10 or the airframe 12.

As shown in FIG. 2 and, in accordance with embodiments, the vibration reduction system 40 may include six force generators 50 disposed on or about the airframe 12 to mitigate or reduce the vibrations of the airframe 12 in six directions. In addition, the vibratory frequency may be a design frequency of the vibration reduction system 40 or a non-design frequency of the vibration reduction system 40. Thus, the vibration reduction system 40 may be operated to mitigate or reduce airframe 12 vibration at a given frequency for which the force generators 50 are designed (i.e., the vibratory frequency caused by the respective rotations of the main rotors 151 and the propeller assembly 160) or to mitigate or reduce airframe 12 vibration at frequencies the force generators 50 are not designed to address (i.e., vibratory content caused by damage to the airframe 12). In the latter case, the controller 60 may be employed to move the masses 53 of the force generators 50 along the corresponding elongate members 52 in order to change a moment arm of the force generator 50 to allow, for example, higher amplitude forces to be generated even if the rotational speed of the force generator 50 is reduced and to allow the force generators 50 to maintain efficiency at different rotational velocities.

It will be understood that although each of the force generators 50 of a given vibration reduction system 40 of an aircraft 10 can be operated similarly by the controller 60, this is not required. In some cases, the controller 60 operates each force generator 50 differently such that one or more force generators 50 can be used to mitigate or reduce vibrations of a first frequency and one or more other force generators 50 can be used to mitigate or reduce vibrations of a second frequency. Thus, in an exemplary case of an aircraft 10 having six force generators 50 and an airframe 12 that is subject to vibrations of a first frequency caused by the respective rotations of the main rotors 151 and the propeller assembly 160 and to vibrations of a second frequency caused by damage, the controller 60 can operate, say, three of the force generators 50 to mitigate or reduce the vibrations of the first frequency and the other three force generators 50 to mitigate or reduce the vibrations of the second frequency.

With reference to FIG. 5, a method of controlling the vibration reduction system 40 is provided. The method includes identifying that the airframe 12 is vibrating at a first frequency (operation 70) and employing the controller 60 to rotate the hub 51 about the axis 510 of a given force generator 50 at the first frequency and to drive a movement of the mass 53 along the elongate member 52 in order to achieve a desired amplitude of force generation for the force generator 50 (operation 71). This should serve to mitigate or reduce the vibration of the airframe 12 at the first frequency. The method further includes identifying that the airframe 12 is vibrating at a second frequency (operation 72) and employing the controller 60 to rotate the hub 51 about the axis 510 of the given force generator 50 at the second frequency and to drive a movement of the mass 53 along the elongate member 52 in order to achieve a new desired amplitude of force generation for the force generator 50 (i.e., a second amplitude) (operation 73). This should serve to mitigate or reduce the vibration of the airframe 12 at the second frequency.

In addition and, as noted above, the first frequency of operation 70 may include one or more first frequencies and the controller 60 may be employed in operation 71 to control one or more force generators 50 to mitigate or reduce each of the one or more first frequencies. Similarly, the second frequency of operation 72 may include one or more second frequencies and the controller 60 may be employed in operation 73 to control one or more force generators 50 to mitigate or reduce each of the one or more second frequencies.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. By way of example, while described in terms of aircraft, it is understood that aspects could be used to mitigate frequencies in maritime and land vehicles, for industrial and household machinery, and other environments where unwanted vibration should be eliminated. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A force generator, comprising:
a hub, which rotates about an axis thereof;
an elongate member coupled to the hub such that the elongate member is rotatable with the hub and extends radially outwardly away from the hub and the axis along a radial dimension defined with respect to the axis; and
a mass, which is movably disposed along the elongate member and is adjustable to multiple radial mass positions relative to the hub.

2. The force generator according to claim 1, wherein the hub comprises a cylindrical body and the axis is a central longitudinal axis of the cylindrical body.

3. The force generator according to claim 2, wherein the elongate member extends radially outwardly from a radial periphery of the hub.

4. The force generator according to claim 1, wherein the elongate member extends perpendicularly with respect to the axis.

5. The force generator according to claim 1, further comprising an actuator to drive a movement of the mass.

6. The force generator according to claim 5, wherein the actuator comprises a rotary actuator which rotates the elongate member to move the mass relative to the hub.

7. The force generator according to claim 5, wherein the actuator comprises a linear actuator which moves the mass relative to the hub along the elongate member.

8. The force generator according to claim 5, wherein the actuator is disposed within the elongate member.

9. The force generator of claim 5, further comprising a controller which controls the actuator to control a movement of the mass along the elongate member and to drive a rotation of the hub about the axis for each force generator to mitigate at least one vibratory frequency having an amplitude.

10. The force generator of claim 9, wherein the controller further changes a rotational speed of the hub and moves the mass to change from one frequency of amplitude X to another frequency having amplitude Y, where the amplitude X is other than the amplitude Y.

11. An aircraft, comprising:
an airframe;
a rotor disposed on the airframe;
a drive system disposed within the airframe and coupled to the rotor to drive a rotation of the rotor relative to the airframe; and
a system comprising:
at least one or more force generators according to claim 1 disposed on the airframe or on components of the rotor or the drive system; and
a controller configured to control a movement of the mass along the elongate member and to drive a rotation of the hub about the axis for each force generator to mitigate or reduce at least one of a vibratory frequency generated by rotor rotation and/or aircraft damage.

12. The aircraft according to claim 11, wherein the vibratory frequency is a design frequency of the system.

13. The aircraft according to claim 11, wherein the vibratory frequency is a non-design frequency of the system, and the controller adjusts the rotation of the hub and a radial location of the mass to mitigate the non-design frequency.
